(19) United States
(12) Patent Application Publication
(10) Pub. No.: US 2026/0237011 A1
(43) Pub. Date: Aug. 13, 2026

(54) CREATING A COMPETITIVE VIRTUAL CLASSROOM ENVIRONMENT

(71) Applicant: INTERNATIONAL BUSINESS MACHINES CORPORATION, ARMONK, NY (US)

(72) Inventors: Sarbajit Kumar Rakshit, Kolkata (IN); Sathya Santhar, CHENNAI (IN); Sridevi Kannan, Chennai (IN)

(21) Appl. No.: 19/049,154

(22) Filed: Feb. 10, 2025

(51) Int. Cl. G06Q 50/20

(52) U.S. Cl. CPC G06Q 50/205

(57) ABSTRACT

An approach is provided for creating a competitive virtual classroom environment. A profile of a first student joining a virtual classroom session is analyzed. Recorded avatars of second students are onboarded, where the second students have previously participated in the virtual classroom session. A competitive learning environment is generated by integrating the first student's real-time actions with the performance of the selected recorded avatar students.

### BACKGROUND

The present invention relates to virtual classroom environments, and more particularly to a method and system for appropriately mixing students using recorded avatars.

### SUMMARY

In one embodiment, the present invention provides a computer-implemented method. The method includes analyzing, by one or more processors, a profile of a first student joining a virtual classroom session. The method further includes onboarding, by the one or more processors, recorded avatars of second students, where the second students have previously participated in the virtual classroom session. The method further includes generating, by the one or more processors, a competitive learning environment by integrating the first student's real-time actions with the performance of the selected recorded avatar students.

A computer system and a computer program product corresponding to the above-summarized computer-implemented method are also described herein.

### BRIEF DESCRIPTION OF THE DRAWINGS

FIG. 1 is a block diagram of a system for creating a competitive virtual classroom environment, in accordance with embodiments of the present invention.

FIG. 2 is a block diagram of modules included in code included in the system of FIG. 1, in accordance with embodiments of the present invention.

FIG. 3 is a flowchart of a process creating a competitive virtual classroom environment, where operations of the flowchart are performed by modules in FIG. 2, in accordance with embodiments of the present invention.

FIG. 4 is an example of creating a competitive virtual classroom environment using the process of FIG. 3, in accordance with embodiments of the present invention.

FIG. 5 is another example of creating a competitive virtual classroom environment using the process of FIG. 3, in accordance with embodiments of the present invention.

FIG. 6 is individual students in a virtual classroom, in accordance with embodiments of the present invention.

FIG. 7 is an avatar creation and recording database, in accordance with embodiments of the present invention.

FIG. 8 is a neural network to predict the Students' ranking based on the collected data from the data base to create competition, in accordance with embodiments of the present invention.

FIG. 9 depicts a chart providing student names and scores and overall ranks, in accordance with embodiments of the present invention.

FIG. 10 depicts a conditional GAN network overview, in accordance with embodiments of the present invention.

FIG. 11 depicts a virtual class created with multiple avatars and competitive responses, in accordance with embodiments of the present invention.

### DETAILED DESCRIPTION

### Overview

Education in virtual reality (VR) refers to the use of immersive technology to create educational experiences that take place in a virtual or simulated environment. In this approach to education, learners can interact with virtual objects, environments, and scenarios that replicate real-world situations and challenges.

Using VR technology, educators can create engaging, interactive, and personalized learning experiences that go beyond traditional classroom settings. For example, learners can explore historical landmarks, perform virtual dissections, practice language skills with native speakers, or even take part in collaborative problem-solving exercises with peers from around the world.

Virtual reality and metaverse education can be used at all levels of education, from elementary school to graduate studies. The technology can also be applied to a wide range of subjects, from science and math to the humanities and the arts.

Overall, education in VR has the potential to enhance learning outcomes, increase student engagement and motivation, and provide learners with access to new opportunities and experiences that may not be possible in traditional classroom settings.

There are many advantages of learning with virtual reality (VR). Here are some of the key benefits:
Enhanced Engagement: VR technology provides an immersive and interactive learning experience that can keep learners engaged and motivated. This can help to improve learning outcomes and retention.
Increased Retention: Because VR experiences are more memorable and immersive than traditional classroom instruction, learners are more likely to retain what they have learned.
Safe Environment: VR can provide a safe environment for learners to practice and experiment with real-world scenarios that may be too dangerous or expensive to replicate in real life. This is particularly useful in fields such as medicine, aviation, and engineering.
Personalized Learning: VR can be used to create personalized learning experiences that cater to individual learner needs and preferences. This can help to improve learning outcomes and engagement.
Access to Remote Learning: VR can provide learners with access to learning experiences that may not be available in their local area. This is particularly useful for learners who are unable to travel or who live in remote locations.
Cost-effective: Virtual reality technology has become more affordable and accessible in recent years, making it an increasingly cost-effective way to provide high-quality education.

Overall, virtual reality has the potential to revolutionize the way we learn and teach, providing an immersive and engaging learning experience that can help learners to achieve their full potential.

Competition in learning can have several advantages, including:
Increased Motivation: Competition can increase motivation, as learners are often driven to perform their best in order to succeed and outperform their peers.
Improved Performance: Competition can improve learning outcomes by encouraging learners to push themselves harder and strive for excellence.
Promotes Innovation and Creativity: Competition can foster innovation and creativity, as learners may be encouraged to think outside the box and come up with new ideas or solutions in order to gain an edge over their competitors.
Develops Resilience: Competition can help learners develop resilience and perseverance, as they learn to overcome setbacks and failures in order to continue striving for success.
Enhances Collaboration: Competition can enhance collaboration, as learners may work together to achieve a common goal or to outperform other teams or individuals.
Preparation for Real-world Challenges: Competition can prepare learners for real-world challenges, where competition is often a key factor in success. By learning to compete effectively, learners can develop valuable skills and traits that will serve them well in their future careers.

Overall, competition in learning can be a powerful motivator that drives learners to perform their best and achieve their goals, while also promoting collaboration, innovation, and resilience.

While attending a class in a prior art VR learning environment, a first student can join at any point of time, and during that time no other students may join in the same VR learning environment. Thus, the first student will not be able to find a competitive environment. The present invention contemplates creating a competitive environment where the appropriate types of students are selected for the virtual class so that at any point of time the first student should feel that he or she is ahead and also behind of some students. Therefore, it is contemplated that the first student understands how the competitors are performing, so that the first student can gradually enhance their performance.

While creating completive virtual classroom environment, the proposed system will be analyzing the profile of the first student who is joining in the virtual classroom session, and accordingly the proposed system will be onboarding performance of recorded avatar of the actual students who joined in different time frame of the same virtual classroom, so that, even though different second students have joined in different time frame in the virtual classroom session, the proposed system will be bringing everybody's performance along with the first student to create competitive virtual class room for the said first student.

While any student attends in any virtual classroom, then the proposed system will be recognizing the said student with his credential, and will be recording performance specific activities of the said student in the virtual classroom (like time to complete any assignment, interaction with teacher, correctness level in the reply etc), and the said student will be recorded as an avatar along with the performance in the virtual classroom, the performance of the students will be recorded,

Considering the evaluation of the performance of different students, the proposed system ranking the recorded avatar of the students, and based on the profile of the first student, the proposed system will be selecting appropriate second users who are recorded as avatar in the knowledge corpus so that competitive environment can be created for the first student.

The present invention will perform simulation of the competitive environment considering appropriate mix of student profile and will be onboarding so that the level of competitiveness can be improved in the virtual reality educational session.

While first student attends in any virtual classroom and the recorded performance of various second students are onboarded in the said virtual classroom, the proposed system will be using GAN to adapt the avatar of the second students aligned with the interaction behavior of the first student, (For example, First student answers to a question in virtual classroom, and it is also identified that the second student also knows the answer, so the second student avatar will be raising his hand) so that the first student can get a competitive learning environment and which is a possible real competitive environment of the actual students,

While constructing virtual classroom with different types of second students, the proposed system will be considering the profile of the first student, historically learnt behavior (like always feels peer pressure, learns form other, follow the best student etc) and accordingly be selecting appropriate types of mix second students in the virtual classroom so that the first student can effectively learn the topic.

While attending virtual classroom, the proposed system will continuously be evaluating the comparative performance of the first student, interaction behavior of the first student, emotional state (like feeling peer pressure etc), and accordingly proposed system will dynamically be altering the mix of appropriate second students.

The present invention can also deploy appropriate dummy avatars to create competitive environment in the metaverse environment.

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer-readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

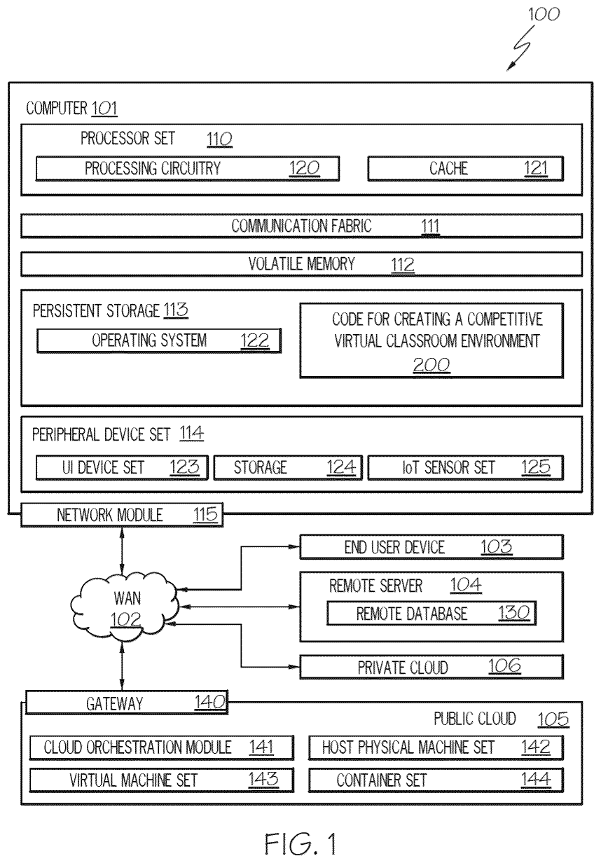

FIG. 1 is a block diagram of a system for creating a competitive virtual classroom environment, in accordance with embodiments of the present invention. Computing environment 100 contains an example of an environment for the execution of at least some of the computer code involved in performing the inventive methods, such as code 200 for creating a competitive virtual classroom environment. The aforementioned computer code is also referred to herein as computer-readable code, computer-readable program code, and machine readable code. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

### System and Process for Creating a Competitive Virtual Classroom Environment

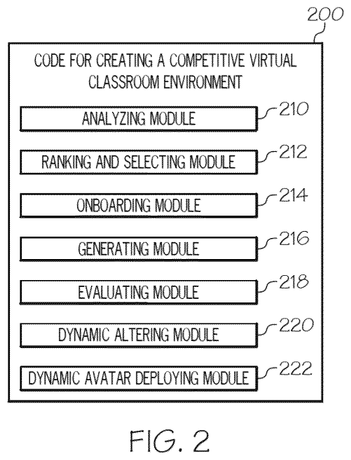

FIG. 2 is a block diagram of modules included in code included in the system of FIG. 1, in accordance with embodiments of the present invention. Code 200 includes an analyzing module 202, a ranking and selecting module 204, an onboarding module 206, a generating module 208, an evaluating module 210, a dynamic altering module 212, and a dynamic avatar deploying module 214.

Analyzing module 202 is configured to analyze, by one or more processors, a profile of a first student joining a virtual classroom session. Thus, the analyzing module 202 maybe configured to analyze a profile including profile data who is joining in the virtual classroom session.

The ranking and selecting module 204 may be configured to rank, by the one or more processors, the recorded avatars based on recorded performance and aligning interactions of the recorded avatars in the generated competitive learning environment with the first student's actions using a generative adversarial network (GAN). The ranking and selecting module 204 may further be configured to select the recorded avatars of the second students based on performance records of the second students. The performance records include at least one of a time to complete assignments, interactions with a teacher, and correctness of responses.

The onboarding module 206 may be configured to onboard, by the one or more processors, recorded avatars of second students, where the second students have previously participated in the virtual classroom session. Thus, the onboarding module 206 may onboard the performance of recorded avatars of the actual students (i.e. second students) who joined the same virtual class at a different time frame, so that, even though different second students have joined at a different time frame, proposed system may bring or import the performance of the other second students, along with the first student, to create competitive virtual class room for the first student.

The generating module 208 may be configured to generate, by the one or more processors, a competitive learning environment by integrating the first student's real-time actions with the performance of the selected recorded avatar students. The generating module 208 may be configured to map different performance with the avatars.

The evaluating module 210 may be configured to evaluate, by the one or more processors, ongoing comparative performance, interaction behavior, and emotional state of the first student within the virtual classroom session. This may occur in real time. The evaluation module 210 may be configured to evaluate the data associated with one or more of the ongoing comparative performance, interaction behavior, and emotional state, which results in the ranking created by the ranking and selecting module 204. Thus, the evaluation module 210 may be configured to evaluate the comparative performance of the first student, interaction behavior of the first student, emotional state (feeling peer pressure, etc.), and the like.

The dynamic altering module 212 may be configured to dynamically alter, in real time, by the one or more processors, the recorded avatars of second students avatars within the virtual classroom session to optimize the competitive environment based on the evaluating the interaction behavior and emotional state of the first student within the virtual classroom. The dynamic altering module 212 may receive information from the evaluating module 210, which is evaluating the performance of the first student in real time. The dynamic altering module 212 may be employed to use this information to make a determination whether the virtual classroom session should be altered by changing the mix of appropriate second students. For example, if a student appears to be struggling, the dynamic altering module 212 may be configured to replace the second students which were ranked higher by the ranking and selecting module 204 with second students which were ranked lower.

The dynamic avatar deploying module 214 may be configured to dynamically deploy, in real time, at least one dummy avatar within the virtual classroom session to optimize the competitive environment based on the evaluating the interaction behavior and emotional state of the first student within the virtual classroom. The dynamic avatar deploying module 214 may be configured to create a competitive environment in the metaverse environment. The dynamic avatar deploying module 214 may create a dummy avatar if a student does not agree to the user of their own avatar, for example.

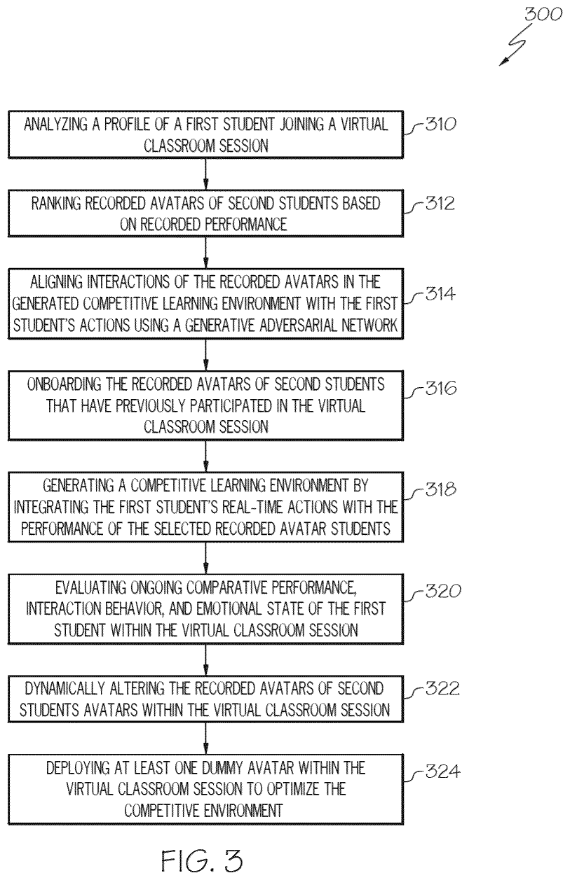

FIG. 3 is a flowchart of a process 300 for creating a competitive virtual classroom environment, where operations of the flowchart are performed by modules in FIG. 2, in accordance with embodiments of the present invention.

The process 300 includes a step 310 of analyzing, by one or more processors, a profile of a first student joining a virtual classroom session. The process 300 includes a step 312 of ranking, by the one or more processors, recorded avatars of second students based on recorded performance and a step 314 of aligning interactions of the recorded avatars in the generated competitive learning environment with the first student's actions using a generative adversarial network (GAN).

The process 300 includes a step 316 of onboarding, by the one or more processors, the recorded avatars of second students, wherein the second students have previously participated in the virtual classroom session. The onboarding may further include selecting the recorded avatars of the second students based on performance records of the second students. The performance records may include at least one of a time to complete assignments, interactions with a teacher, and correctness of responses.

The process 300 further includes a step 318 of generating, by the one or more processors, a competitive learning environment by integrating the first student's real-time actions with the performance of the selected recorded avatar students.

The process 300 may additionally or alternatively include a step 320 of evaluating, by the one or more processors, ongoing comparative performance, interaction behavior, and emotional state of the first student within the virtual classroom session. Further, the process 300 may additionally or alternatively include a step 322 of dynamically altering, by the one or more processors, the recorded avatars of second students avatars within the virtual classroom session to optimize the competitive environment based on the evaluating the interaction behavior and emotional state of the first student within the virtual classroom. Additionally or alternatively, the process 300 may include deploying, by the one or more processors, at least one dummy avatar within the virtual classroom session to optimize the competitive environment based on the evaluating the interaction behavior and emotional state of the first student within the virtual classroom.

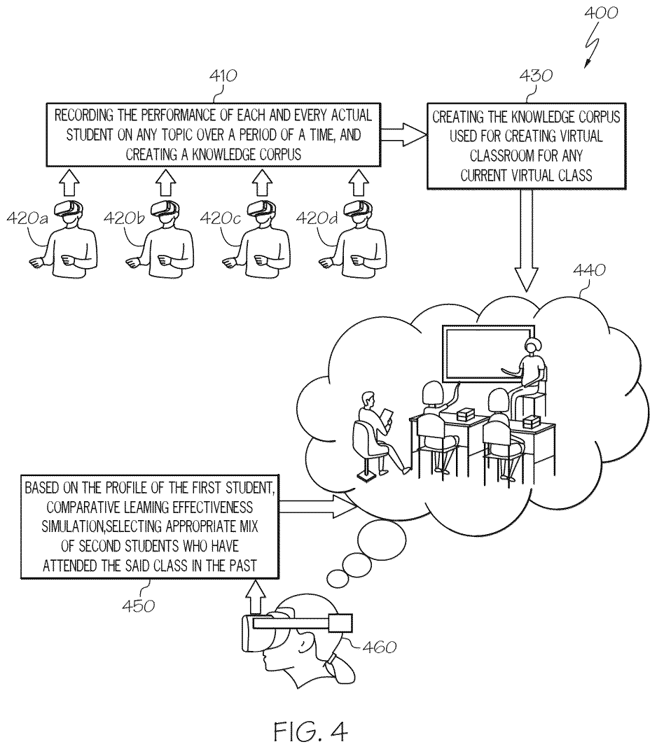

FIG. 4 is an example of creating a competitive virtual classroom environment 400 using the process of FIG. 3, in accordance with embodiments of the present invention.

The proposed competitive virtual classroom environment 400 may be configured to record the performance of different second users over a period of a time, on any learning content, and the same will be stored in the knowledge corpus, and accordingly while any first student joins in any virtual learning session. The competitive virtual classroom environment 400 may select an appropriate mix of second students so that learning effectiveness of the first student is increased.

As shown, various students 420a, 420b, 420c, 420d take a virtual class at different dates. At a step 410, the methods and systems contemplated herein record the performance of each and every actual student on any topic over a period of time, including the various students 420a, 420b, 420c, 420d. The methods and systems contemplated herein then create a knowledge corpus from this information. At a step 430, the methods and systems contemplated herein create the knowledge corpus and the use this knowledge corpus for creating virtual classrooms for any current virtual class. At a step 440, the methods and systems contemplated herein utilize an avatar creation module will consider the recorded performance of these second students 420a, 420b, 420c, 420d in creating the virtual classroom for a new first student 460 taking the class.

At a step 450, the methods and systems contemplated herein may, based on the profile of the first student 460, embodiments may select an appropriate mix of the second students who have attended the classroom in the past.

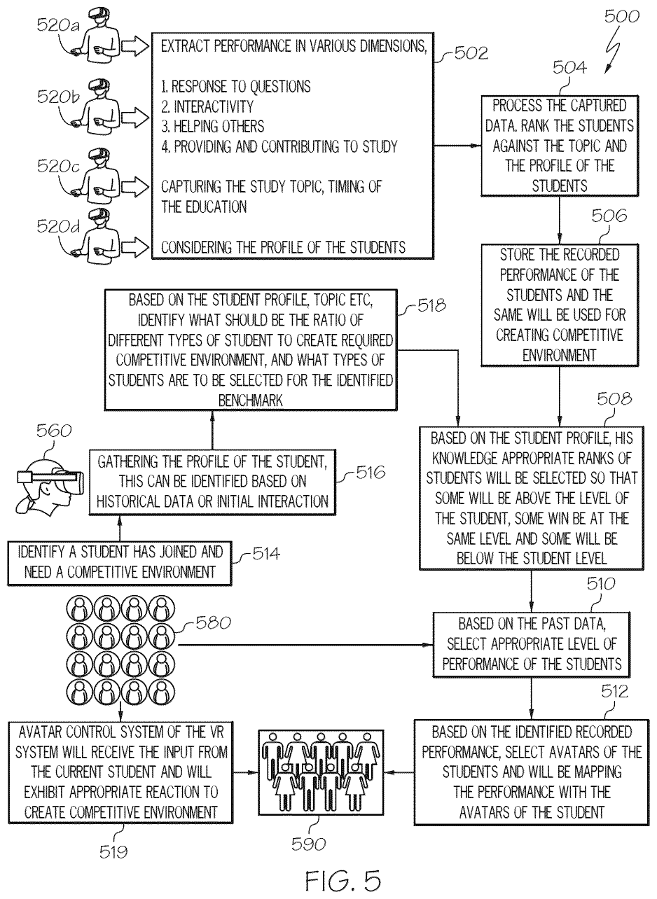

FIG. 5 is another example of creating a competitive virtual classroom environment 500 using the process of FIG. 3, in accordance with embodiments of the present invention.

The competitive virtual classroom environment 500 contemplates second students having joined the virtual classroom in the past. Embodiments contemplated herein have captured the performance, interaction, participation etc., of these second students and may be configured to rank these second students as per their performance. If any new first students join the virtual class, then the competitive virtual classroom environment 500 may be configured to identify which mix of students are to be considered so that competitive environment can be created for the first student.

As shown, various students 520a, 520b, 520c, 520d take a virtual class at different dates. At a step 502 methods and systems contemplated herein extract performance of the various students 520a, 520b, 520c, 520d in various dimensions, such as response to questions, levels of interaction, helping others, providing and contributing to study, and the like. Methods and systems contemplated herein may also capture the study topic, timing of the dimension and may further consider the profile o the various students 520a, 520b, 520c, 520d.

At a step 504, methods and systems contemplated herein process the captured data, rank the students against the topic and the profile of the students. Further, at a step 506 methods and systems contemplated herein store the recorded performance of the students, whereby the recording will be used for creating a competitive work environment.

At a step 514, methods and systems contemplated herein identify a first student 560 has joined the virtual classroom and needs a competitive environment. At a step 516, methods and systems contemplated herein gather the profile of the first student 560, which can be identified based on historical data or an initial interaction by the first student 560 with the virtual classroom system. At a step 518, based on the student profile and/or the topic of the virtual class, methods and systems contemplated herein may be configured to identify what should be the ratio of different types of students to create a competitive classroom environment for the first student 560, and what types of students are to be selected for the identified benchmark.

At a step 508, methods and systems contemplated herein will select students based on the student profiles, knowledge appropriate ranks of students, such that some of the virtual second students 520a, 520b, 520c, 520d are at the same level as the first student 560 currently taking the class, and some are above and some are below the level of the first student 560. At a step 510, based on the past data, methods and systems contemplated herein may select appropriate levels of performance of the second student avatars for the virtual classroom. At a step 512, based on the identified record performance, methods and systems contemplated herein may select avatars of the second students 520a, 520b, 520c, 520d and may be mapping the performance with the avatars of the student. An avatar repository 580 may be used for the selection of the avatars at step 512. At a step 590, the virtual classroom environment is created for the first student 560. At a step 519, methods and systems contemplated herein include an avatar control system which will receive input in real time of the current student 560 and will exhibit appropriate reactions to create a continued competitive environment.

Expanding upon the embodiments shown in FIGS. 4-5, while attending in any Virtual Classroom session, the proposed system may record the performance specific parameters of the student. Such performance specific parameters can be time to response, levels of interaction, participation in discussion, correctness in response, etc. While recording the performance-specific information, the proposed system may be analyzing the behavioral pattern of the students, such as when a student raises their hand while responding, or responding to the question, confidence level etc. While different students are attending the virtual classroom, the proposed system may be recognizing the student, topic learned, and also be considering the profile of the student. The proposed system may record the educational performance of the student on that topic and will be stored in the knowledge corpus. The same recording information may be considered as the second students who have previously taken the class. The proposed system may also capture the behavior, biometric parameters of the students, interaction pattern, performance of the student with respect to other student and change in behavior etc. The proposed system may consider the interaction behavior, change in behavior with respect to other student's performance etc. This may be stored as a profile of the student.

While attending in any virtual classroom, the profile system may identify the first student has joined in the virtual classroom. The proposed system may identify what types of second student mix is to be selected in the virtual classroom. Based on the identified profile, behavior of the first student, the proposed system may perform AI simulation to identify appropriate fix of second students. During this simulation, the proposed system may consider how the first students' behavior is changed based on the performance of the second student, and if the first student improves performance. Based on the historical data about the performance simulation, the proposed system may identify what types of learning effectiveness will increase. The proposed system may further identify appropriate types of recorded performance are to be onboarded along with the first student. Further, the proposed system may identify a topic or topics selected by the first student while attending in the virtual classroom. Based on the selected topic, the proposed system may select an appropriate combination of second students recorded performance.

The present systems and methods contemplate having an avatar generation module, and each of the selected recorded performance to be onboarded in the virtual classroom, the proposed system may map different performance with the avatars. The proposed system may onboard the second students on the said virtual classroom along with the first student. Based on the context of the learning, the proposed system may identify how the second students have exhibited their reaction when they have learned.

The proposed system may use GAN to modify the avatar of the appropriate second students in the virtual classroom. The proposed system may track the performance of the first student with respect to the second students, and how the first user is behaving, and whether learning effectiveness is increasing. Based on the in-process detection of the behavior and interaction of the first student, the proposed system may alter the mix of appropriate second students, so that the learning effectiveness in increase.

Embodiments contemplated include methods to capture each and every student's interaction, performance, contribution etc, in virtual reality educational session.

The present systems and methods contemplate having a comprehensive system to capture students' interactions, performance, contributions, in the virtual reality educational session, and then using that data to create avatars stored on an educational server. The VR device may capture the motion of the students with hand tracking, track the answer provided by the student, will capture the educational content against which the student has responded, date and time of the participation in the VR educational content.

The present systems and methods contemplate capturing students' interactions, performance, and contributions, the remote data collection system will be receiving each and every students' performance, interaction pattern, This could include tracking head and hand movements, voice interactions, interactions with virtual objects, quiz scores, participation in group discussions, etc.

The present systems and methods may include a user authentication system to uniquely identify each student in the VR sessions. This could be tied to their educational institution's identity management system. The present systems and methods may further include secure and scalable data storage to store the captured data. This could involve databases, cloud storage, or a combination of both. The present systems and methods may include data processing pipelines to analyze the captured data. This could involve using machine learning algorithms to assess performance, contributions, and interactions. For instance, sentiment analysis on voice interactions, object interaction patterns, or quiz performance analysis. Each and every student's performance, interaction etc. may be captured against with each educational content, map which educational content the student has interacted etc.

Embodiments contemplated include methods to use the analyze the captured data and which can be used for creating avatar of the student.

The captured data from each student in different time frame may be analyzed and may be identifying comparative performance score of each of the student. The performance score for each student may be identified individually for each study topic, the performance score will be evaluated based on defined performance score by the VR educational session. The performance score may be measured based on correctness of responding, levels of interaction, number of correct answers, contributes to the educational session etc. The virtual reality educational system may have predefined rules, and the same will be used for calculating the performance score.

The present systems and methods may include a student profile evaluation system, it will capture historical performance, knowledge level, topic of interest etc. Based on the performance store, on different educational topic or VR educational session, the proposed system may rank the students who have participated in the past.

The present systems and methods may include an avatar creation module, based on students' data, it will use the student specific data, to create avatar of the student, in this avatar can be a dummy avatar, if the student is not agreeing to use his avatar. Each and every student's avatar may be mapped with their performance on the class, and may be identifying what questions are responded, which are not, what types of interaction were performed etc.

An educational server may store and manage the created avatars of the students who have already joined at any time frame. These avatars could be associated with each student's identity, in this case, their performance and relative ranks will also be mapped. The present systems and methods may ensure appropriate security is maintained of the avatars of the students are stored securely and that the system complies with privacy regulations, especially when dealing with students' personal information. The VR educational content provider may connect to the student performance or educational database enabling the avatar and performance of the students can be overlaid over the VR educational content. This could involve APIs and secure communication protocols.

Embodiments contemplated herein include methods to identify any new student joins in the class and wants to have competitive educational environment, and what types of students are to be selected who have joined in the past.

When any student login in any virtual reality class, methods and systems herein may identify the detail about the student, and identify if the student has addended the class before or is a new topic he is going to learn or a Known topic, at the same time. Methods and systems herein may identify the profile of the student.

The present systems and methods may review the academic records of new students to assess their performance in previous VR session, his level of participation etc, based on historical data invention will assess a student's portfolio to evaluate their skills and creativity. This can provide a glimpse into their potential to excel in a competitive environment.

Based on historical information, the present systems and methods may identify group activities of the student, and what types of participation is performed by the student. The present systems and methods may have a Benchmark Identification module; the benchmarks will be identified based on the student's current performance. These benchmarks could be incremental and achievable milestones that lead to their larger academic goal. The present systems and methods may define the benchmarks for each category of learning, like collaboration, interaction, correctness in reply etc. and based on historical data, invention will identify the rate of improvement if the student.

The present systems and methods may continuously collect data on the student's performance through assignments, quizzes, tests, and projects. Use formative assessments to monitor their progress and identify trends over time. Based on historical rate of progression, the present systems and methods may compare the student's performance to the established benchmarks and will project whet should be the benchmark level. The present systems and methods may identify areas where they have met or exceeded benchmarks and areas that need further improvement. Based on the historically data collection, progress of the student, benchmarks level can be adjusted such as consideration of raising the bar as the student improves.

A student can also define the benchmark while attending in the class; the benchmark may enable a student to get encouragement on their journey, their accomplishments, and areas where the student improved. In this case, the benchmark can be quantifiable, such as level of correctness in the reply, timing, level of interest in participation, level of involvement in the reply etc. The present systems and methods may consider the benchmark level for any student, and accordingly based on historically participant's data invention will identify what types of students who have joined in the past should be considered in the VR educational session.

The present systems and methods may select appropriate students from the historical database who have joined in the past, which can replicate the required level of benchmark and competitive environment. The present systems and methods may identify appropriate mix of students in the virtual class room, who can create the competitive environment. The present systems and methods may identify appropriate number of students who are above the current student, some of at same level and some are below the current student.

The present systems and methods may gather performance data for each student, such as test scores, assignment grades, or other relevant metrics and calculate the percentile rank for each student's performance based on the collected data. Percentiles may indicate the percentage of students who scored lower than a particular student. The present systems and methods may determine the competitive levels to categorize students into, such as “Above Average,” “Average,” and “Below Average.” The present systems and methods may use the calculated percentiles to assign students to appropriate competitive levels. For example: Students in the top 10% of percentiles could be classified as “Above Average;” Students in the middle 50% could be classified as “Average”; and Students in the bottom 10% could be classified as “Below Average.”

Further contemplated are methods to identify how a VR educational environment is to be updated with historically participated student's avatar and exhibit the interaction.

Once appropriate ratio of students are identified, an appropriate number of avatar students to a virtual reality classroom involves creating a realistic and engaging learning environment. Choose avatar representations of the student, may be identified based on the participation of the students in the past. In some embodiments, diverse avatar representations may be selected which mimic students of considered from the past. The present systems and methods may integrate interactive features like virtual whiteboards, collaborative documents, and shared screens and allow avatars to engage in group activities, breakout sessions, and team-based projects.

Once the avatars are selected, then the avatars to exhibit natural behavior like moving around the classroom, interacting with objects, and engaging in conversations. The present systems and methods may simulate reactions to questions, discussions, and activities to create an immersive experience, based on their past performance. Overall, the avatars will be assigned with appropriate level of performance so that the avatars can exhibit the performance in the class.

Further contemplated herein are methods to analyze the current participants' performance, and how the augmented students will be interacting to create a competitive environment with the current student.

The present systems and methods may may analyze the current participants' performance and facilitating interaction between augmented students and current students to create a competitive environment. The present systems and methods may gather performance data of current students, including test scores, assignment grades, participation, and other relevant metrics. The present systems and methods may analyze this data to understand the distribution of performance levels and identify students who excel, are average, or need improvement.

The present systems and methods may consider the selected benchmarked level for different performance levels based on the analysis, and accordingly the avatars will be creating interaction in the virtual reality class like they have attended along with the current student. Once the avatars are placed on the VR environment, then the VR avatars may be integrated into the virtual classroom environment where current students interact and will ensure that the avatars respond dynamically to interactions, challenges, and activities.

The avatars shown on the VR educational session may exhibit the same interaction as they have shown in the past and was recorded. The present systems and methods may simulate interactions between augmented avatars and current students during classroom activities, discussions, quizzes, or debates. The avatars may exhibit behaviors reflective of their categorized performance levels.

The VR educational environment may include a module to control or adapt the avatars, the augmented avatars to adapt their responses based on the actions of current students. Avatars can become more competitive or collaborative depending on the context. The present systems and methods may capture the real-time feedback to both current students and augmented avatars. Highlight areas of improvement, strengths, and weaknesses to foster a competitive environment, and will be used for changing the benchmark and will also be changing the avatars. The present systems and methods may create challenges or scenarios where augmented avatars compete with current students in a controlled manner. These challenges could involve problem-solving tasks, debates, or collaborative projects.

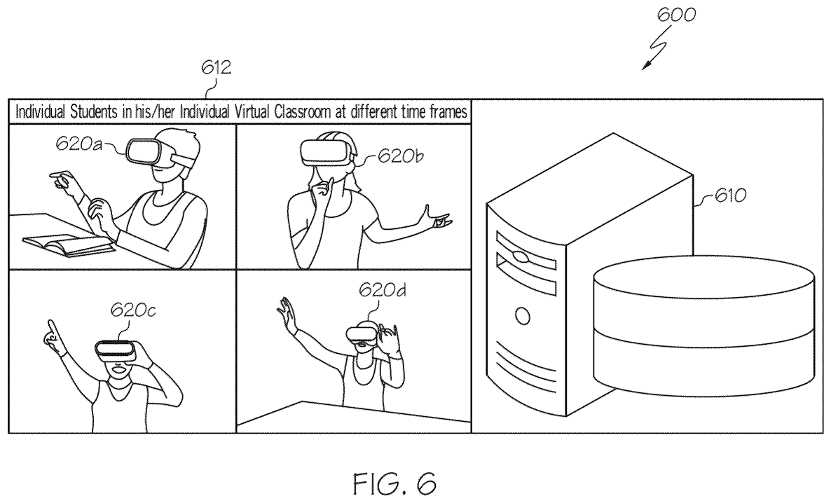

FIG. 6 is individual students 620a, 620b, 620c, 620d in a virtual classroom 612, in accordance with embodiments of the present invention. As shown, the individual students 620a, 620b, 620c, 620d have performance recorded over a period of time, whereby information and data associated with those recorded performances is stored in a database collection of performance 610. This creates a knowledge corpus.

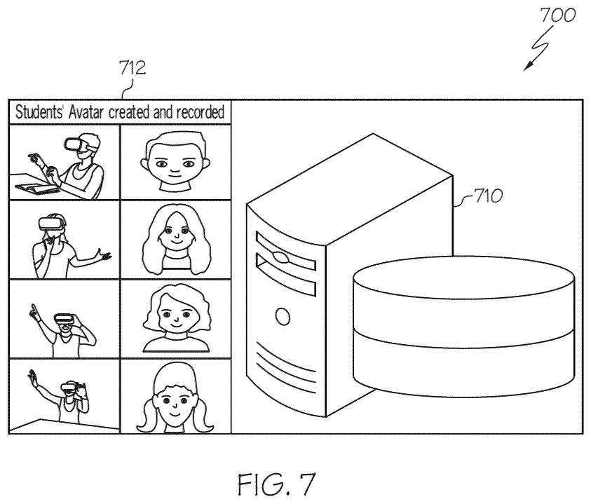

FIG. 7 is an avatar creation and recording database 710 of the system for creating a virtual classroom environment 700, in accordance with embodiments of the present invention. As shown, the students' avatars 712 may be created based on their physique and features which are also recorded in the database. The students' performance metrics may be recorded in the database and may be passed into a neural network one by one to predict the Students' combination in the virtual class and their corresponding rankings based on the collected data from the data base to create competitive environment for the input student.

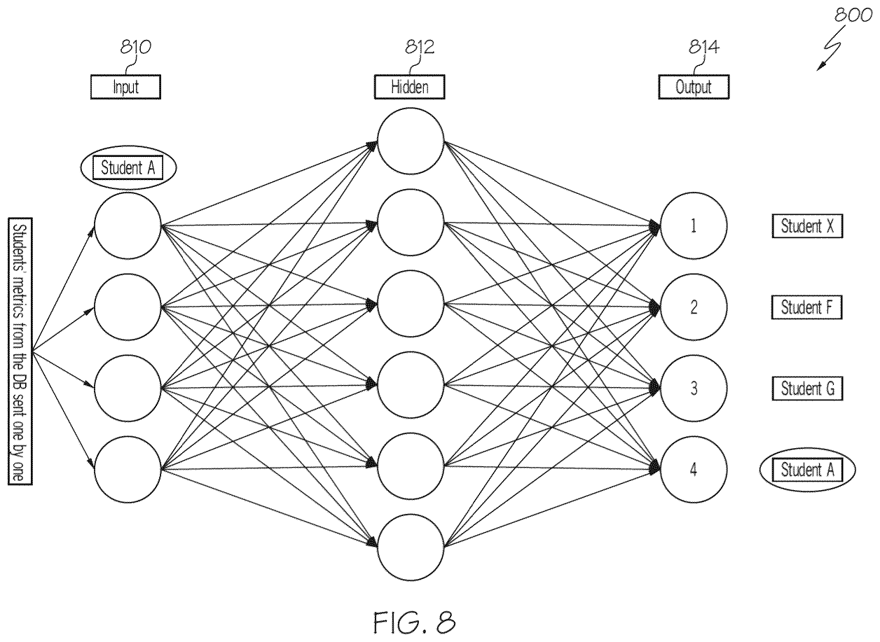

FIG. 8 is a neural network 800 to predict the Students' ranking based on the collected data from the data base to create competition, in accordance with embodiments of the present invention. The neural network 800 includes an input layer 810, a hidden layer 812, and an output layer 814. The input layer 810 may include student metrics from the database 710, for example. The hidden layer 812 may be configured to enable prediction of a student ranking based on the collected data from the database to create a competitive classroom environment. The output layer 814 may predict the students who could be part of the virtual classroom based on individual performance metrics.

For example, when a record of Student A is passed into the neural network as input it analyzes the other students' record from the database and selects the specific students (X, F, G) who would be compatible and competitive for the given input student's virtual classroom. The classroom student selection is dynamic and based on the current performance of the input student the student selection keeps happening in the neural network thereby creating a competitive environment. The neural network predicts the student combination in a class for the input student's performance and ranks those corresponding students based on their interactive/listening/responsive skills and creates a competitive student selection process.

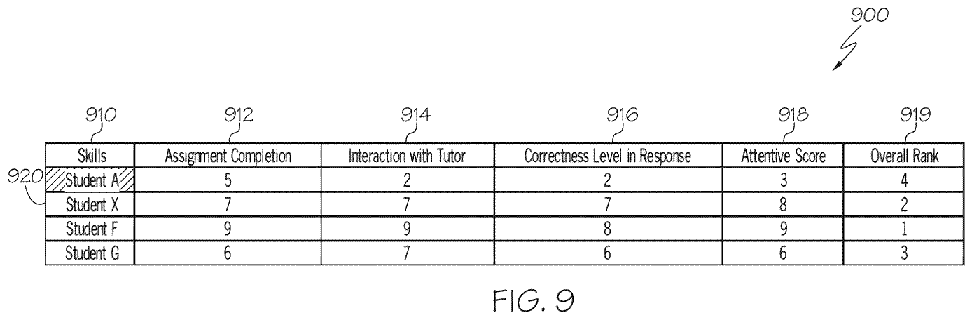

FIG. 9 depicts a chart 900 providing student names and scores and overall ranks, in accordance with embodiments of the present invention. The chart 900 includes exemplary data associated with students 920 and skills 910. The skills include assignment completion skills 912, interaction with tutor skills 914, correctness level in response skills 916, attentive score skills 918, and overall ranking 919. Various datapoints are assigned to each student 920 for each skill, such as a ranking between 1-10 in the embodiment shown.

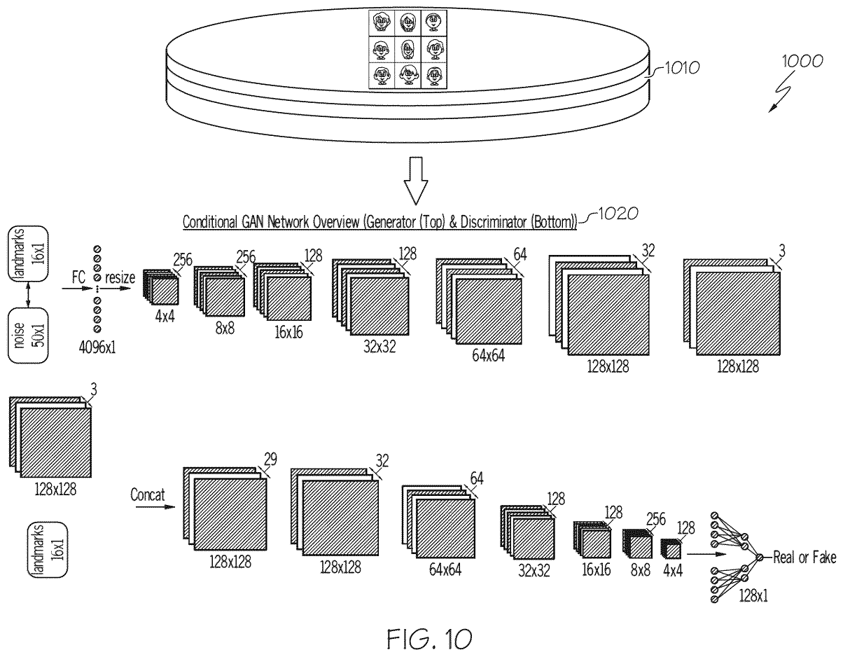

FIG. 10 depicts a conditional GAN network overview 1000, in accordance with embodiments of the present invention. The conditional GAN network overview 1000 includes a database 1010 in which GAN is trained on creating avatar responses based on the interaction, score and/or behavior scores and ranking of the students. Further, a conditional GAN network overview 1020 is further shown connected to the database 1010, including generator and discriminator. The GAN network may be conditioned with the students' avatar and responses to be made available in the same classroom to create a competitive environment.

The conditional GAN network overview 1000 may be employed to create a virtual competitive environment for the input student based on the student selection from the previous step. The selected students' avatars are conditioned to the model and the GAN may be previously trained on creating a virtual classroom with the students' avatars and their behaviors and responses/gestures to the other student's interaction in the classroom thereby creating a competitive environment for the students to learn virtually.

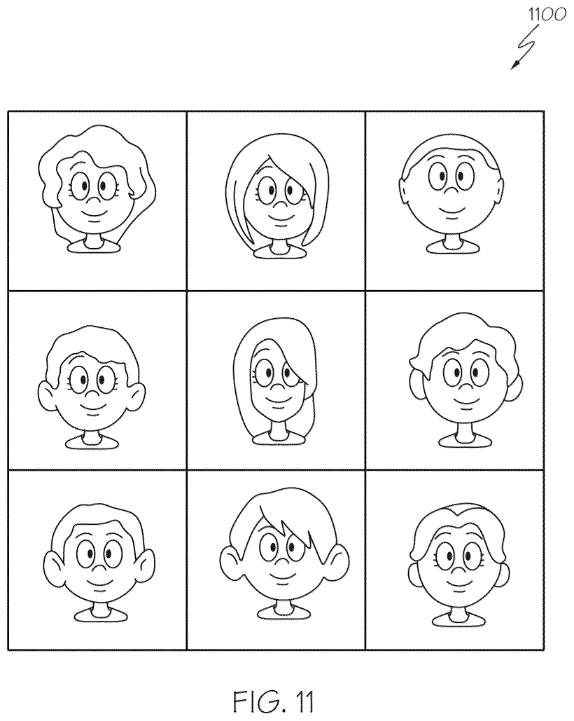

FIG. 11 depicts a virtual class 1100 created with multiple avatars and competitive responses, in accordance with embodiments of the present invention.

The descriptions of the various embodiments of the present invention have been presented herein for purposes of illustration but are not intended to be exhaustive or limited to the embodiments disclosed. Many modifications and variations will be apparent to those or ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method, comprising:
creating, by one or more processors, a virtual classroom session;
analyzing, by the one or more processors, a profile of a first student joining the virtual classroom session, wherein the joining of the first student to the virtual classroom session is via a virtual reality (VR) device associated with the first student;
selecting, by the one or more processors, recorded avatars of second students based on performance records of the second students, wherein
the second students have previously participated in the virtual classroom session, and
the recorded avatars are stored on a server capable of communicating with the VR device;
generating, by the one or more processors, a competitive learning environment by integrating actions of an avatar of the first student with performance of the selected recorded avatars of the second students, wherein the actions of the avatar of the first student are captured by the VR device associated with the first student;
controlling, by the one or more processors using a generative adversarial network (GAN), interactions of the recorded avatars of the second students in the virtual classroom session based on the actions of the first student;
evaluating, by the one or more processors, an ongoing comparative performance of the first student, an interaction behavior of the first student, and an emotional state of the first student in the virtual classroom session; and
replacing, by the one or more processors, the recorded avatars of the second students with recorded avatars of third students in the virtual classroom session based on the evaluating, wherein the third students are different from the second students.

2. The computer-implemented method of claim 1, further comprising:
ranking, by the one or more processors, the recorded avatars of the second students based on the performance records of the second students.

3. (canceled)

4. (canceled)

5. The computer-implemented method of claim 1, further comprising:
deploying, by the one or more processors, at least one dummy avatar within the virtual classroom session to optimize the competitive learning environment based on the evaluating of the interaction behavior and the emotional state of the first student within the virtual classroom session.

6. (canceled)

7. (canceled)

8. A computer system, comprising:
one or more processors;
one or more computer-readable storage media; and
program instructions stored on the one or more computer-readable storage media to cause the one or more processors to perform operations comprising:
creating, by the one or more processors, a virtual classroom session;
analyzing, by the one or more processors, a profile of a first student joining the virtual classroom session, wherein the joining of the first student to the virtual classroom session is via a virtual reality (VR) device associated with the first student;
selecting, by the one or more processors, recorded avatars of second students based on performance records of the second students, wherein
the second students have previously participated in the virtual classroom session, and
the recorded avatars are stored on a server capable of communicating with the VR device;
generating, by the one or more processors, a competitive learning environment by integrating actions of an avatar of the first student with performance of the selected recorded avatars of the second students, wherein the actions of the avatar of the first student are captured by the VR device associated with the first student;
controlling, by the one or more processors using a generative adversarial network (GAN), interactions of the recorded avatars of the second students in the virtual classroom session based on the actions of the first student;
evaluating, by the one or more processors, an ongoing comparative performance of the first student, an interaction behavior of the first student, and an emotional state of the first student in the virtual classroom session; and
replacing, by the one or more processors, the recorded avatars of the second students with recorded avatars of third students in the virtual classroom session based on the evaluating, wherein the third students are different from the second students.

9. The computer system of claim 8, wherein operations further comprise:
ranking, by the one or more processors, the recorded avatars of the second students based the performance records of the second students.

10. (canceled)

11. (canceled)

12. The computer system of claim 8, wherein operations further comprise:
deploying, by the one or more processors, at least one dummy avatar within the virtual classroom session to optimize the competitive learning environment based on the evaluating of the interaction behavior and the emotional state of the first student within the virtual classroom session.

13. (canceled)

14. (canceled)

15. A computer program product, comprising:
one or more computer-readable storage media; and
program instructions stored on the one or more computer-readable storage media to perform operations comprising:
creating, by one or more processors, a virtual classroom session;
analyzing, by the one or more processors, a profile of a first student joining the virtual classroom session, wherein the joining of the first student to the virtual classroom session is via a virtual reality (VR) device associated with the first student;
selecting, by the one or more processors, recorded avatars of second students based on performance records of the second students, wherein
the second students have previously participated in the virtual classroom session, and
the recorded avatars are stored on a server capable of communicating with the VR device;
generating, by the one or more processors, a competitive learning environment by integrating actions of an avatar of the first student with performance of the selected recorded avatars of the second students, wherein the actions of the avatar of the first student are captured by the VR device associated with the first student;
controlling, by the one or more processors using a generative adversarial network (GAN), interactions of the recorded avatars of the second students in the virtual classroom session based on the actions of the first student;
evaluating, by the one or more processors, an ongoing comparative performance of the first student, an interaction behavior of the first student, and an emotional state of the first student in the virtual classroom session; and
replacing, by the one or more processors, the recorded avatars of the second students with recorded avatars of third students in the virtual classroom session based on the evaluating, wherein the third students are different from the second students.

16. The computer program product of claim 15, wherein the operations further comprise:
ranking, by the one or more processors, the recorded avatars of the second students based on the performance records of the second students.

17. (canceled)

18. (canceled)

19. The computer program product of claim 15, wherein the operations further comprise:
deploying, by the one or more processors, at least one dummy avatar within the virtual classroom session to optimize the competitive learning environment based on the evaluating of the interaction behavior and the emotional state of the first student within the virtual classroom session.

20. (canceled)
